(19) United States
(12) Patent Application Publication
(10) Pub. No.: US 2014/0309837 A1
(43) Pub. Date: Oct. 16, 2014

(54) AUTOMATIC DRIVING CONTROL SYSTEM

(71) Applicant: HYUNDAI MOBIS CO., LTD., Seoul (KR)

(72) Inventor: Jun Ho Ham, Yongin-si (KR)

(73) Assignee: HYUNDAI MOBIS CO., LTD., Seoul (KR)

(21) Appl. No.: 14/218,618

(22) Filed: Mar. 18, 2014

(30) Foreign Application Priority Data
Apr. 11, 2013 (KR) 10-2013-0040039

(51) Int. Cl. G05D 1/02

(52) U.S. Cl. CPC G05D 1/0223
USPC 701/25

(57) ABSTRACT

Disclosed is an automatic driving control system including a road curvature calculating unit that receives shape information of a road ahead from a navigation to calculate curvatures of the road ahead, an optimum speed calculating unit that calculates optimum speeds on the basis of the curvatures of the road calculated by the road curvature calculating unit and selects speed control points, and a target acceleration calculating unit that receives information from the optimum speed calculating unit and calculates a target acceleration on the basis of the calculated optimum speeds and a current speed of a vehicle.

### CROSS-REFERENCE TO RELATED APPLICATIONS

This application claims priority to and the benefit of Korean Patent Application No. 10-2013-0040039 filed in the Korean Intellectual Property Office on Apr. 11, 2013, the entire contents of which are incorporated herein by reference.

### TECHNICAL FIELD

The present invention relates to an automatic driving control system, and more particularly, to an automatic driving control system with which it is possible to automatically control the speed of the vehicle to the optimum speed by obtaining the shape information of the road ahead from the navigation 10 during longitudinal autonomous driving to calculate the optimum speed for allowing the vehicle to drive on the curved road comfortably and safely.

### BACKGROUND ART

In recent years, the market of products for performing automatic driving control of a vehicle that automatically control driving in order to provide convenience to a driver tends to be gradually extended. For this reason, the development of a smart cruise control (SCC) system has been actively progressed. For example, cruise control that maintains the vehicle at a constant set speed and adaptive cruise control products that maintain an appropriate distance between the vehicle and a preceding vehicle by including the cruise control and using a radar have been widely available.

In this regard, the development of an automatic driving control system that provides an automatic decelerating function in order to control a speed on a curved road on the basis of road information has been progressed.

Unfortunately, in the conventional method of controlling the speed on the curved road, since speed control is mostly performed using a point requiring the largest deceleration among curvatures of the road ahead, it may be difficult to perform smooth control in consideration of a comfortable ride, and discontinuous control may be performed. In order to solve the problems, or in order to respond a complicate curved road, excessive deceleration control may be performed.

Most existing technologies use a uniform acceleration required to decelerate the speed, and since the uniform acceleration is different from a physical or actual control input, a comfortable ride, control accuracy, and control robustness may be adversely affected.

In some conventional technologies, since a point of time when deceleration control is performed is not clear, a problem of excessive or insufficient deceleration control may be caused for the curved road ahead. Since vehicle acceleration for smooth speed control is not sufficiently considered in most cases, the comfortable ride may be decreased, and it may be difficult to obey an optimum speed.

### SUMMARY OF THE INVENTION

The present invention has been made in an effort to provide an automatic driving control system capable of automatically controlling a speed of a vehicle to an optimum speed by obtaining shape information of a road ahead from a navigation during longitudinal autonomous driving to calculate the optimum speed for allowing the vehicle to drive on a curved road comfortably and safely.

An exemplary embodiment of the present invention provides an automatic driving control system including: a road curvature calculating unit that receives shape information of a road ahead from a navigation to calculate curvatures of the road ahead; an optimum speed calculating unit that calculates optimum speeds on the basis of the curvatures of the road calculated by the road curvature calculating unit and selects speed control points; and a target acceleration calculating unit that receives information from the optimum speed calculating unit and calculates a target acceleration on the basis of the calculated optimum speeds, the control points, and a current speed of a vehicle.

The road curvature calculating unit may receive a shape of the road ahead from the navigation, as coordinates having a predetermined distance, and calculate radii of curvatures of the road ahead by using a radius of a circumscribed circle passing through three valid road coordinates.

The optimum speed calculating unit may calculate the optimum speeds by using the following equation on the basis of the curvatures of the road calculated by the road curvature calculating unit and a predetermined optimum lateral acceleration value:

V=\sqrt{A_{y}r}

where V is an optimum speed, A_{y} is an optimum lateral acceleration, and r is a radius of curvature.

The optimum speed calculating unit may calculate out-of-range distances by adding a predetermined distance based on the current speed of the vehicle and distances required to decelerate the current speed to the optimum speeds for the calculated optimum speeds of the road ahead, and when the calculated out-of-range distance is within a predetermined out of range, the optimum speed may not be considered for speed control.

The optimum speed calculating unit may calculate the out-of-range distances at the optimum speeds by using the following equation for the calculated optimum speeds of the road ahead:

$$D ( {V}_{map} ) = {D}_{0} + ( V ( 0 ) * Th ) + ( \frac{{V ( 0 )}^{2} - {V}_{map}^{2}}{2 A} )$$

where Vmap is an optimum speed of a point ahead, D(Vmap) is an out-of-range distance for Vmap, D0 is a set constant distance, V(0) is a current vehicle speed, Th is a timegap, and A is a preference deceleration.

The optimum speed calculating unit may calculate required uniform decelerations based on a current vehicle speed up until reaching distances to coordinates of the calculated optimum speeds of the road ahead, and select a coordinate requiring the largest deceleration among the required uniform decelerations, as a first control point.

The optimum speed calculating unit may select a coordinate having the smallest optimum speed from among all optimum speeds in which a speed difference between the calculated optimum speeds of the road ahead and the current vehicle speed is within a preset speed difference, as a second control point.

The target speed calculating unit may receive whether or not the control point is present, a distance to the control point, and an optimum speed of the control point, from the optimum speed calculating unit, and select a deceleration control characteristic on the basis of the current vehicle speed and a previous target acceleration.

As the deceleration control characteristic, one of finite deceleration characteristic sets of a maximum allowable acceleration of the target acceleration, a maximum change rate of the target acceleration and a speed proportional control gain may be selected in a preset order.

The target acceleration calculating unit may calculate the target acceleration by using the following equation:

Aᵢ=Kₘ(Vₘₐₚ−V(0))

where Ai is a target acceleration, Km is a final control gain, Vmap is an optimum speed of a road, and V(0) is a current vehicle speed.

The automatic driving control system may further include a final target acceleration calculating unit that calculates a final target acceleration on the basis of a target acceleration calculated by the target acceleration calculating unit and a target acceleration calculated by a smart cruise control system.

According to exemplary embodiments of the present invention, it is possible to automatically control the speed of the vehicle to the optimum speed by obtaining the shape information of the road ahead from the navigation during longitudinal autonomous driving to calculate the optimum speed for allowing the vehicle to drive on the curved road comfortably and safely.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an overall configuration diagram of an automatic driving control system according to an exemplary embodiment of the present invention.

FIG. 2 is a diagram for describing a method of calculating a radius of curvature of a road ahead.

FIG. 3 is a graph for describing an out of range excluded from a control target among optimum speeds of the road ahead.

FIG. 4 is a graph for describing a method of selecting two control points.

FIG. 5 is a block diagram illustrating a procedure for calculating target acceleration by a target acceleration calculating unit.

FIG. 6 is a flowchart illustrating an operating method of the automatic driving control system.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. It should be noted that throughout the accompanying drawings, the same components are assigned the same reference numerals even in different drawings. The exemplary embodiments of the present invention will now be described, but the technical spirit of the present invention is not limited or restricted thereto. Therefore, it should be appreciated that those skilled in the art can variously change and modify these embodiments.

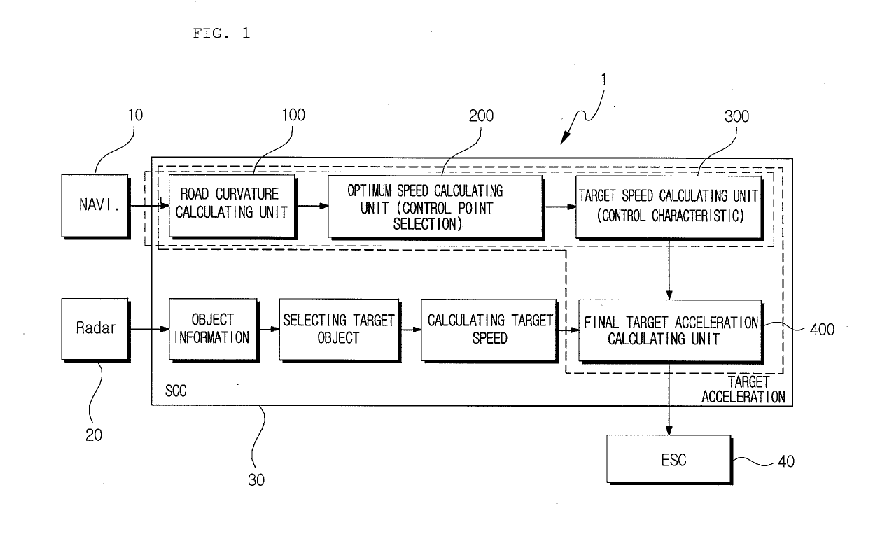

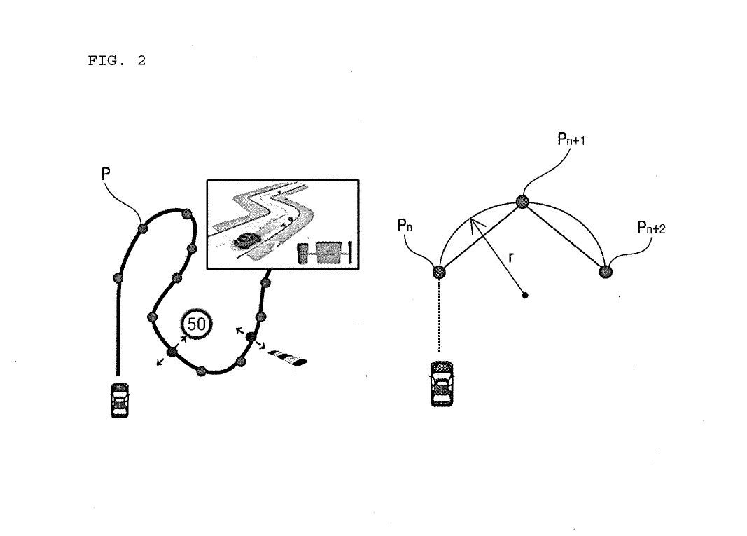

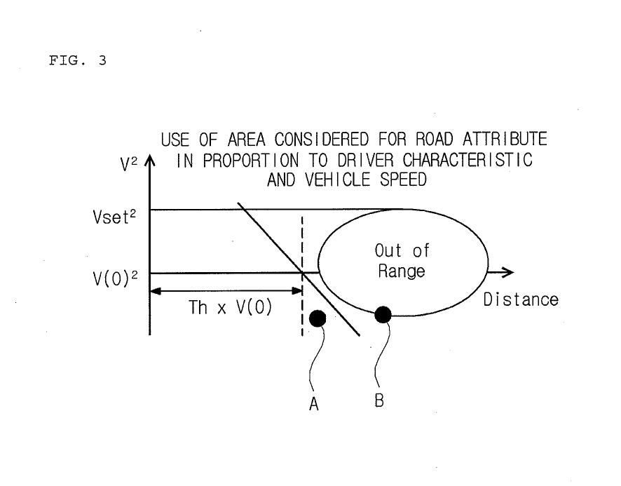

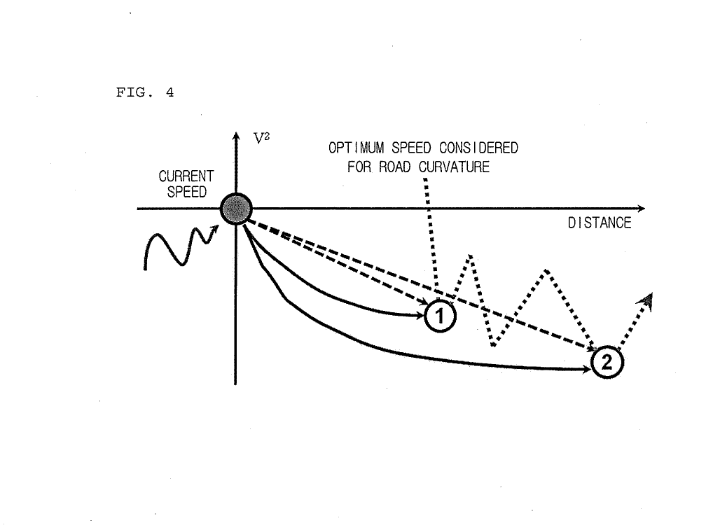

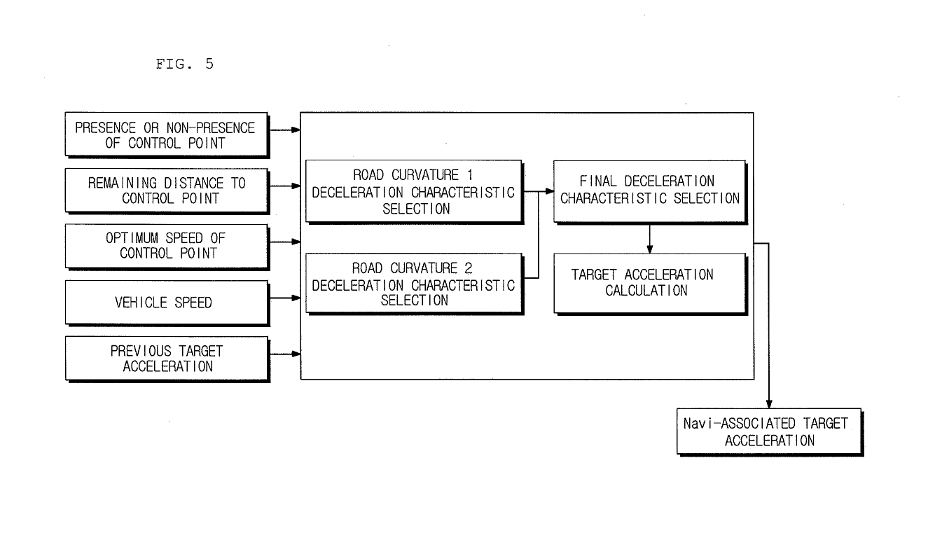

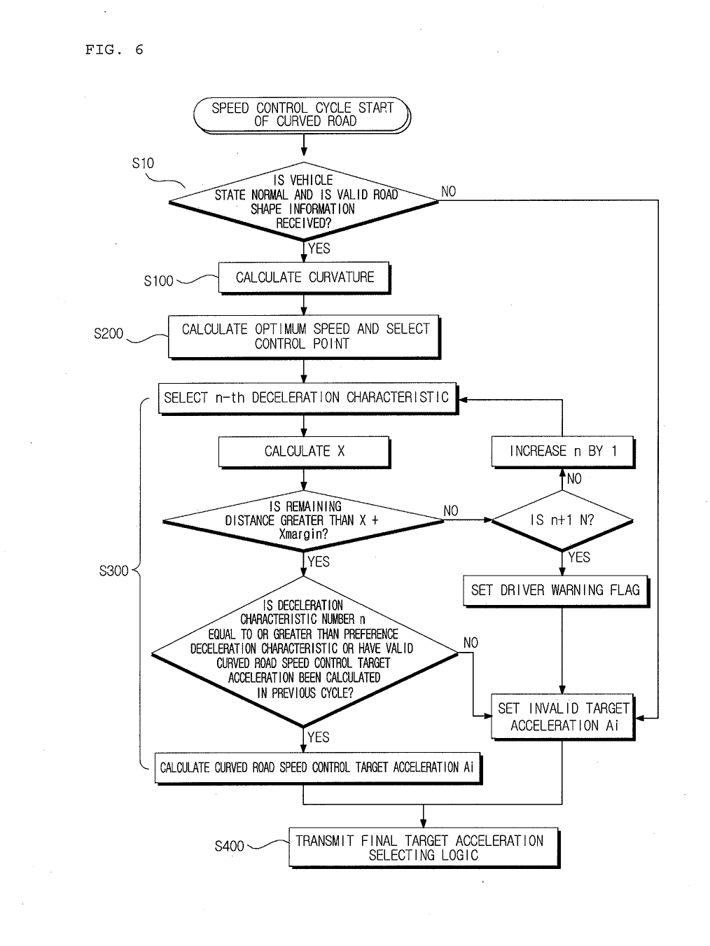

FIG. 1 is an overall configuration diagram of an automatic driving control system according to an exemplary embodiment of the present invention, FIG. 2 is a diagram for describing a method of calculating a radius of curvature of a road ahead, FIG. 3 is a graph for describing a method of selecting a control position, FIG. 4 is a graph for describing an out of range excluded from a control target among optimum speeds of the road ahead, FIG. 5 is a graph for describing a method of selecting two control points, FIG. 6 is a block diagram illustrating a procedure for calculating a target acceleration, and FIG. 7 is a flowchart illustrating an operating method of the automatic driving control system.

Referring to these drawings, an automatic driving control system 1 according to an exemplary embodiment of the present invention includes a road curvature calculating unit 100 that receives shape information of a road ahead from a navigation 10 to calculate curvatures of the road ahead, an optimum speed calculating unit 200 that calculates optimum speeds on the basis of the road curvatures calculated by the road curvature calculating unit 100 and selects speed control points, and a target acceleration calculating unit 300 that receives information from the optimum speed calculating unit 200 and calculates a target acceleration on the basis of the calculated optimum speeds and a current speed of a vehicle.

The road curvature calculating unit 100 receives a shape of the road ahead from the navigation 10, as coordinates having a certain distance, and calculates radii of curvatures of the road ahead by using a radius of a circumscribed circle passing through three valid road coordinates.

Since the shape of the road ahead is received as the coordinates from the navigation 10, the number of the received road coordinates may be changed depending on a communication condition between vehicles, and the coordinates may be received through several communication.

Referring to FIG. 2, in order to calculate the radii of curvatures, when at least three or more coordinates P are received, the road curvature calculating unit starts to calculate the curvatures. The curvatures of the road ahead are calculated by primarily using the radius of the circumscribed circle passing through three points (Pₙ, Pₙ₊₁, Pₙ₊₂). However, in some cases, the curvatures may be calculated through a method using an inscribed circle, a change of a distance between coordinates, a change of an azimuth, or an interpolation line such as a spline.

The optimum speed calculating unit 200 receives information on the calculated curvatures of the road ahead by the road curvature calculating unit 100 to calculate the optimum speeds by using a centrifugal force formula and selects deceleration control points.

The optimum speed calculating unit 200 calculates the optimum speeds by using the following equation on the basis of a predetermined optimum lateral acceleration value and the road curvature calculated by the road curvature calculating unit 100:

V=\sqrt{A_{y}r} [Equation 1]

where V is an optimum speed, A_{y} is an optimum lateral acceleration, and r is a radius of curvature.

The optimum lateral acceleration is a pre-selected value allowing the vehicle to safely move and a driver to feel comfortable when the vehicle runs on a curved road, and is selected in consideration of a friction coefficient of the road. The optimum speeds depending on the curvatures of the road ahead may be calculated using a curvature radius and optimum speed table that is previously written using such formula.

Subsequently, the optimum speed calculating unit 200 specifies an optimum speed to be considered for deceleration control from among the optimum speeds of the road ahead, which are calculated through the above-stated procedure.

In a method of specifying the optimum speed, out-of-range distances are calculated by adding a certain distance based on the current speed of the vehicle and a distance required to decelerate the current speed up to the optimum speed for each of the calculated optimum speeds, and when the calculated out-of-range distance is within a predetermined out of range, the optimum speed is not considered for speed control. That is, by setting a range in which the distance required for deceleration control is long as the predetermined out of range and by selecting two control points for deceleration control from among ranges other than the range, it is possible to reduce unnecessary calculations in selecting the control points of the curved road, and it is possible to respond a continuous curved road.

The optimum speed calculating unit 200 calculates the out-of-range distance for each of the optimum speed speeds by using the following equation for the calculated optimum speeds of the road ahead:

$$D ( {V}_{map} ) = {D}_{0} + ( V ( 0 ) * Th ) + ( \frac{{V ( 0 )}^{2} - {V}_{map}^{2}}{2 A} ) \qquad [ Equation 2 ]$$

where Vmap is an optimum speed at a point ahead, D(Vmap) is an out-of-range distance for each Vmap, D0 is a set constant distance, V(0) is a current vehicle speed, Th is a timegap, and A is a preference deceleration.

Referring to FIG. 3, the optimum speed calculating unit 200 previously determines the out of range in proportion to a driver characteristic and a vehicle speed, and then considers, as control targets for deceleration control, optimum speeds in a case (A) where the out of range distances are not within the out of range but exclusive of a case (B) where the out of range distances are within the out of range, among the calculated optimum speeds.

The optimum speed calculating unit 200 calculates required uniform decelerations based on the current vehicle speed up until reaching distances to coordinates of the optimum speeds in the case where the out-of-range distances are not within the out of range, and selects, as a first control point, a coordinate requiring the largest deceleration among the required uniform decelerations.

The required uniform deceleration is calculated using the following equation:

$$\frac{{V ( 0 )}^{2} - {V}_{map}^{2}}{2 \cdot d} = A \qquad [ Equation 3 ]$$

where V(0) is a current vehicle speed, Vmap is an optimum speed at a point ahead to be considered, d is a distance to the point ahead to be considered, and A is a required uniform deceleration.

Since a maximum required uniform deceleration point is not appropriate to perform proportional control, a control point considering a proportional control section is selected as a second control point. Referring to FIG. 4, it can be seen that the maximum required uniform deceleration point is a point \textcircled{1}, and a maximum proportional deceleration control requiring point is a point \textcircled{2}.

Accordingly, the optimum speed calculating unit 200 selects, as a second control point, a coordinate having the smallest optimum speed among all optimum speeds in which a speed difference between the calculated optimum speeds of the road ahead and the current vehicle speed is within a preset speed difference. At this time, the preset speed difference may be changed in consideration of the current vehicle speed and acceleration.

Referring to FIG. 5, the target acceleration calculating unit 300 receives information from the optimum speed calculating unit 200, and calculates target acceleration on the basis of the calculated optimum speeds and control points and the current vehicle speed.

The target acceleration calculating unit 300 receives whether or not the control point is present, a distance to the control point, and the optimum speed of the control point, from the optimum speed calculating unit 200, and selects a deceleration control characteristic on the basis of the current vehicle speed and a previous target acceleration.

As the deceleration control characteristic, one of finite deceleration characteristic sets of a maximum allowable acceleration of a target acceleration, a maximum change rate of the target acceleration and a speed proportional control gain is selected in a preset order:

Aₘₐₓ={Aₘₐₓ(n)|A₁, A₂, A₃, . . . , A_{N}}

Jₘₐₓ={Jₘₐₓ(n)|J₁, J₂, J₃, . . . , J_{N}}

Kₘ={Kₘ(n)|K₁, K₂, K₃, . . . , K_{N}}

v_{margin}={v_{margin}(n)|v₁, v₂, v₃, . . . , v_{N}}

where Aₘₐₓ is a maximum allowable acceleration of the target acceleration, Jₘₐₓ is a maximum change rate jerk of the target acceleration, and Km is a speed proportional control gain (a control speed), and V_{margin} is a margin speed as a difference between the optimum speed and the target control speed.

In the present invention, as described above, the control is performed by selecting an optimum driving characteristic from among sets of various discontinuous driving characteristic values.

For example, a distance x(n) required to decelerate a current vehicle speed V(0) up to a limit speed Vt by using the n-th deceleration characteristic is as follows:

x(n)=x₁(n)+x₂(n)+x₃(n)

vₘₐₚ=vₜ−v_{margin}(n)

where x(n) is a distance required to decelerate the current vehicle speed up to the speed limit Vt when the deceleration control is performed using the n-th deceleration characteristic. x1 is a distance of a deceleration increase section, x2 is a distance of a normal deceleration section, and x3 is a distance of a speed proportional control section.

As described above, in the present invention, a precise deceleration control distance can be calculated in consideration of all influences of acceleration limit, acceleration change rate limit, and feedback control. A control target speed and the optimum speed to be reduced are allowed to be different, so that it is possible to allow the current vehicle speed to be equal to or less than the optimum speed within a finite time while performing feedback proportional control.

The target acceleration calculating unit 300 compares a remaining distance to an optimum speed point with a deceleration-required distance. When the remaining distance is shorter than the deceleration-required distance, the target acceleration calculating unit calculates a deceleration-required distance by selecting the next deceleration characteristic (n+1) from among the above-described deceleration characteristics.

When there is no deceleration characteristic to be selected, the target acceleration calculating unit sends a driver warning signal, and selects the last deceleration characteristic. When the remaining distance is greater than the deceleration-required distance, the target acceleration calculating unit selects a current deceleration characteristic number n and determines whether to start curved road speed control.

When valid curved road speed control target acceleration has not been calculated in a previous circle and the selected deceleration characteristic number is equal to or less than a preset level in consideration of a driver characteristic and setting, the target acceleration calculating unit does not start association control performed by receiving information from the navigation 10. In this case, the target acceleration calculating unit outputs invalid navigation (10)-associated target acceleration.

When valid navigation (10)-associated target acceleration has been calculated in the previous circle or the selected deceleration characteristic is equal to or more than a certain level, the target acceleration calculating unit calculates a navigation (10)-associated target deceleration by using the deceleration characteristic. At this time, when the deceleration characteristic is equal to or greater than a certain level, the target acceleration calculating unit generates the driver warning signal, as described above.

Specifically, the target acceleration calculating unit 300 calculates target acceleration by using the following equation:

Aᵢ=Kₘ(Vₘₐₚ−V(0)) [Equation 4]

where Ai is a target acceleration, Km is a final control gain, Vmap is an optimum speed of a road, and V(0) is a current vehicle speed.

The target acceleration Ai is calculated by a typical speed proportional control method, and an absolute value thereof is restricted by the allowable maximum acceleration Amax, and a change rate thereof is restricted by the allowable maximum acceleration change rate Jmax.

Meanwhile, the automatic driving control system 1 of the present exemplary embodiment further includes a final target acceleration calculating unit 400 that calculates a final target acceleration on the basis of the target acceleration calculated by the target acceleration calculating unit 300 and a target acceleration calculated by a smart cruise control (SSC) system 30.

For example, the final target acceleration calculating unit 400 may select, as a final target acceleration, a minimum value of the target acceleration calculated by the target acceleration calculating unit 300 and the target acceleration calculated by the smart cruise control system. The final target acceleration calculated by the final target acceleration calculating unit 400 is sent to an electronic stability control (ESC) 40. The ESC 40 drives an engine and an electronic braking unit so as to follow the target acceleration sent from the automatic driving control system 1.

An operation of the automatic driving control system 1 having the above-stated configuration is described as follows.

The automatic driving control system 1 of the present exemplary embodiment is configured in parallel with the existing smart cruise control system (SCC) 30 to be operated independently from the smart cruise control system 30.

Referring to FIG. 6, prior to the start of the system, it is determined whether or not the automatic driving control system 1 is operated by determining whether or not a vehicle state is normal and valid road shape information is received (S10).

When receiving the valid road shape information, the road curvature calculating unit 100 calculates the curvatures of the road ahead on the basis of the road shape information (S100).

Subsequently, the optimum speed calculating unit 200 calculates the optimum speeds at points of the curved road by using the curvatures of the road ahead, and selects the control points for providing a comfortable and safe speed control function to the driver, from among the calculated optimum speeds of the road ahead, regardless of a complicate road shape (S200).

The target acceleration calculating unit 300 calculates a required target deceleration in order to obey the calculated optimum speed (S300). At this time, the target acceleration calculating unit performs adaptive control by selecting an optimum control characteristic, from among preference deceleration characteristics that are set in advance, depending on driving conditions. The target acceleration calculating unit calculates a distance required to decelerate the current vehicle speed up to a new limit speed by using a control characteristic to be desired to use, and compares a curved road speed control starting distance to which a margin distance is added with a remaining distance to an optimum speed point ahead to send a signal so as to start control. Accordingly, it is possible to minimize an excessive or insufficient deceleration due to the curved road speed control.

The final target acceleration calculating unit 400 sends, to the ESC 40, a final target acceleration of a control vehicle by appropriately mixing and selecting the navigation (10)-associated target acceleration calculated by the target acceleration calculating unit 300 and the target acceleration calculated by the existing SCC 30 (S400).

The ESC 40 drives the engine and the electronic braking unit so as to follow the target acceleration received from the automatic driving control system 1.

As described above, according to the automatic driving control system 1 of the present invention, it is possible to automatically control the speed of the vehicle to the optimum speed by obtaining the shape information of the road ahead from the navigation 10 during longitudinal autonomous driving to calculate the optimum speed for allowing the vehicle to drive on the curved road comfortably and safely.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An automatic driving control system, comprising:
a road curvature calculating unit that receives shape information of a road ahead from a navigation to calculate curvatures of the road ahead;
an optimum speed calculating unit that calculates optimum speeds on the basis of the curvatures of the road calculated by the road curvature calculating unit and selects speed control points; and
a target acceleration calculating unit that receives information from the optimum speed calculating unit and calculates a target acceleration on the basis of the calculated optimum speeds, the control points, and a current speed of a vehicle.

2. The automatic driving control system of claim 1, wherein the road curvature calculating unit receives a shape of the road ahead from the navigation, as coordinates having a predetermined distance, and calculates radii of curvatures of the road ahead by using a radius of a circumscribed circle passing through three valid road coordinates.

3. The automatic driving control system of claim 1, wherein the optimum speed calculating unit calculates the optimum speeds by using the following equation on the basis of the curvatures of the road calculated by the road curvature calculating unit and a predetermined optimum lateral acceleration value:
V=\sqrt{A_{y}r}
where V is an optimum speed, A_{y} is an optimum lateral acceleration, and r is a radius of curvature.

4. The automatic driving control system of claim 1, wherein the optimum speed calculating unit calculates out-of-range distances by adding a predetermined distance based on the current speed of the vehicle and distances required to decelerate the current speed to the optimum speeds for the calculated optimum speeds of the road ahead, and when the calculated out-of-range distance is within a predetermined out of range, the optimum speed is not considered for speed control.

5. The automatic driving control system of claim 1, wherein the optimum speed calculating unit calculates required uniform decelerations based on a current vehicle speed up until reaching distances to coordinates of the calculated optimum speeds of the road ahead, and selects a coordinate requiring the largest deceleration among the required uniform decelerations, as a first control point.

6. The automatic driving control system of claim 1, wherein the optimum speed calculating unit selects a coordinate having the smallest optimum speed from among all optimum speeds in which a speed difference between the calculated optimum speeds of the road ahead and the current vehicle speed is within a preset speed difference, as a second control point.

7. The automatic driving control system of claim 1, wherein the target speed calculating unit receives whether or not the control point is present, a distance to the control point, and an optimum speed of the control point, from the optimum speed calculating unit, and selects a deceleration control characteristic on the basis of the current vehicle speed and a previous target acceleration.

8. The automatic driving control system of claim 7, wherein as the deceleration control characteristic, one of finite deceleration characteristic sets of a maximum allowable acceleration of the target acceleration, a maximum change rate of the target acceleration and a speed proportional control gain is selected in a preset order.

9. The automatic driving control system of claim 1, wherein the target acceleration calculating unit calculates the target acceleration by using the following equation:
Aᵢ=Kₘ(Vₘₐₚ−V(0))
where Ai is a target acceleration, Km is a final control gain, Vmap is an optimum speed of a road, and V(0) is a current vehicle speed.

10. The automatic driving control system of claim 1, further comprising:
a final target acceleration calculating unit that calculates a final target acceleration on the basis of a target acceleration calculated by the target acceleration calculating unit and a target acceleration calculated by a smart cruise control system.

11. An automatic driving control method, comprising steps of:
(a) receiving shape information of a road ahead from a navigation to calculate curvatures of the road ahead;
(b) calculating optimum speeds on the basis of the curvatures of the road and selecting speed control points; and
(c) calculating a target acceleration on the basis of the calculated optimum speeds, the control points, and a current speed of a vehicle.

12. The automatic driving control method of claim 11, wherein the step (a) comprising:
receiving a shape of the road ahead from the navigation, as coordinates having a predetermined distance, and calculating radii of curvatures of the road ahead by using a radius of a circumscribed circle passing through three valid road coordinates.

13. The automatic driving control method of claim 11, wherein the step (b) comprising:
calculating out-of-range distances by adding a predetermined distance based on the current speed of the vehicle and distances required to decelerate the current speed to the optimum speeds for the calculated optimum speeds of the road ahead, and when the calculated out-of-range distance is within a predetermined out of range, the optimum speed is not considered for speed control.

14. The automatic driving control method of claim 11, wherein the step (b) comprising:
calculating required uniform decelerations based on a current vehicle speed up until reaching distances to coordinates of the calculated optimum speeds of the road ahead, and selecting a coordinate requiring the largest deceleration among the required uniform decelerations, as a first control point.

15. The automatic driving control method of claim 11, wherein the step (b) comprising:
selecting a coordinate having the smallest optimum speed from among all optimum speeds in which a speed difference between the calculated optimum speeds of the road ahead and the current vehicle speed is within a preset speed difference, as a second control point.

16. The automatic driving control method of claim 11, wherein the step (c) comprising:
receiving whether or not the control point is present, a distance to the control point, and an optimum speed of the control point, and selecting a deceleration control characteristic on the basis of the current vehicle speed and a previous target acceleration.

17. The automatic driving control method of claim 16, wherein as the deceleration control characteristic, one of finite deceleration characteristic sets of a maximum allowable acceleration of the target acceleration, a maximum change rate of the target acceleration and a speed proportional control gain is selected in a preset order.

18. The automatic driving control method of claim 11, further comprising:
(d) calculating a final target acceleration on the basis of the target acceleration calculated by the step (c) and a target acceleration calculated by a smart cruise control system.
